(19) United States
(12) Patent Application Publication
(10) Pub. No.: US 2010/0079610 A1
(43) Pub. Date: Apr. 1, 2010

(54) PHOTOGRAPHIC APPARATUS AND PHOTOGRAPHIC CONTROL METHOD, IMAGE DISPLAY APPARATUS AND IMAGE DISPLAY METHOD, AND PHOTOGRAPHIC SYSTEM AND CONTROL METHOD THEREOF

(76) Inventor: Masako SUEHIRO, Kanagawa (JP)

Correspondence Address: BIRCH STEWART KOLASCH & BIRCH, PO BOX 747, FALLS CHURCH, VA, 22040-0747, US

(21) Appl. No.: 12/566,192

(22) Filed: Sep. 24, 2009

(30) Foreign Application Priority Data
Sep. 29, 2008 (JP) NO. 2008-251423

(51) Int. Cl. H04N 5/228

(52) U.S. Cl. 348/222.1; 348/E05.031

(57) ABSTRACT

A photographic apparatus comprising:
an imaging device that periodically drives an imaging element during a still image photographing mode to photograph a plurality of images and which performs actual photographing of a still image when a photographing instruction is input;
a subject detecting device that detects an arbitrary subject from an image photographed prior to the actual photographing;
a measuring device that measures a period of time over which the subject had been continuously detected by the subject detecting device; and an output device that outputs the measured period of time.

### BACKGROUND OF THE INVENTION

1. Field of the Invention

The present invention relates to a photographic apparatus, and a photographic control method, an image display apparatus and an image display method, and a photographic system and a control method thereof. More particularly, the present invention relates to a photographic apparatus and a photographic control method, an image display apparatus and an image display method, and a photographic system and a control method thereof which set photographic conditions and playback methods in accordance with a period of time over which a subject had been tracked before performing actual photographing.

2. Description of the Related Art

When performing photographing, a photographer performs actual photographing after checking a live view displayed in a viewfinder or a monitor of a camera to position a subject in a photographic angle of view and deciding on a composition. In addition, in some cases, after deciding on a composition, a photographer may wait until a subject moves in a certain way and perform actual photographing in synchronization with the movement of the subject.

Japanese Patent Application Laid-Open No. 2006-287911 discloses an apparatus comprising: a required time-for-imaging counting unit which counts a period of time over which an operation for capturing an image of a subject is continuously performed by a user; an importance calculating unit which calculates a degree of importance of a captured image based on the required time for imaging counted by the required time-for-imaging counting unit; and an output control unit which causes an image whose degree of importance calculated by the importance calculating unit is greater to be displayed or printed at a greater size. According to this apparatus, the user is now able to use an image that is important to the user such as an image painstakingly captured by carefully choosing a photo opportunity as a cover of an album or position the image in a most prominent position in the album.

When photographing is carefully performed by a photographer, it is conceivable that the time between positioning a subject within a photographic angle of view and performing actual photographing becomes longer. However, the required time-for-imaging counting unit according to Japanese Patent Application Laid-Open No. 2006-287911 counts, as a required time for imaging, a period of time in which operations by the user to cause an imaging unit to capture a subject such as focus adjustment and shutter speed adjustment at or within predetermined time intervals, or a period of time between when the imaging unit is set to an imaging-enabled state with respect to the subject and when it is judged that the user is touching the release button. However, the required time-for-imaging counting unit according to Japanese Patent Application Laid-Open No. 2006-287911 makes no determination on whether or not the subject is positioned within a photographic angle of view.

In addition, with respect to performing actual photographing, no arrangement is made to measure and record a period of time over which a photographer had tracked a subject and to use the measured and recorded period of time in the automatic configuration of photographic conditions and playback methods.

### SUMMARY OF THE INVENTION

The present invention has been made in consideration of such circumstances, and an object thereof is to provide a photographic apparatus and a photographic control method, an image display apparatus and an image display method, and a photographic system and a control method thereof which output a period of time over which a subject is tracked before performing actual photographing.

In order to achieve the object described above, a photographic apparatus according to the present invention comprises: an imaging device that periodically drives an imaging element during a still image photographing mode to photograph a plurality of images and which performs actual photographing of a still image when a photographing instruction is input;

a subject detecting device that detects an arbitrary subject from an image photographed prior to the actual photographing;

a measuring device that measures a period of time over which the subject had been continuously detected by the subject detecting device; and

an output device that outputs the measured period of time.

As described above, by measuring a period of time over which a subject had been continuously detected and outputting the measured period of time, a photographer is able to obtain an indicator of photographing.

Preferably, the imaging device performs actual photographing of one still image frame in association with a single photographing instruction when the measured period of time upon input of the photographing instruction is less than a first threshold, and consecutively at a predetermined time interval performs actual photographing of a plurality of still image frames in association with a single photographing instruction when the measured period of time upon input of the photographing instruction is equal to or greater than the first threshold.

Accordingly, it is now possible to reliably shoot a photographically-desirable instant without missing photo opportunities.

Preferably, the photographic apparatus further comprises a device which detects an amount of a displacement of the photographic apparatus during the period of time over which a subject is continuously detected by the subject detecting device, wherein

conditions of actual photographing are set according to a movement speed of the photographic apparatus calculated based on the detected amount of the displacement or on the detected amount of the displacement and the measured period of time.

Accordingly, an optimum photographic condition in accordance with a subject can be set.

Preferably, the greater the detected amount of the displacement or the greater the calculated movement speed, the higher the shutter speed or the photographic sensitivity during actual photographing is to be set.

Accordingly, an optimum photographic condition in accordance with a subject can be set.

Preferably, the output device includes a recording control device that records a still image taken by actual photographing and the measured period of time with associating the still image with the measured period of time.

Accordingly, the search efficiency of still images during playback can be increased.

The recording control device may record images of a predetermined time interval among images photographed prior to the actual photographing when the measured period of time reaches or exceeds a second threshold before the photographing instruction is input.

Accordingly, even when a photo opportunity is missed, the conditions during photographing can be retained as a record.

Preferably, the measuring device measures a period of time over which each of a plurality of subjects detected by the subject detecting device is continuously detected, and

the recording control device records a still image taken by actual photographing and the measured periods of time of photographed subjects in the still image with associating the still image with the measured period of time.

Accordingly, it is now possible to record a measured period of time related to a recorded still image. Preferably, the recording control device records the still image taken by actual photographing and the detected amount of the displacement with associating the still image with the measured period of time.

Accordingly, a displacement detected during playback of a still image can be used.

In order to achieve the object described above, an image display device according to the present invention is an image display device which plays back and displays a still image recorded by the photographic apparatus according to any of the fifth to eighth aspects of the present invention on a display device, the image display device comprising:

a device which acquires a still image recorded by the photographic apparatus and a measured period of time recorded in association with the still image;

a device which determines a display size of the still image based on the acquired measured period of time; and

a device which lists and displays a plurality of the acquired still images on the display device based on the determined display size.

In this manner, since the present invention is arranged so as to determine a display size of a still image based on a measured period of time and to perform listing and display based on the determined display size, a user can efficiently find a desired image.

In order to achieve the object described above, an image display device according to the present invention is an image display device which plays back and displays a still image recorded by the photographic apparatus according to any of the fifth to eighth aspects of the present invention on a display device, the image display device comprising:

a device which acquires a still image recorded by the photographic apparatus and a measured period of time recorded in association with the still image;

a device which determines a display time of the still image based on the acquired measured period of time; and

a device which sequentially plays back and displays a plurality of the acquired still images on the display device based on the determined display time.

In this manner, since the present invention is arranged so as to determine a display time of a still image based on a measured period of time and to sequentially play back and display images based on the determined display time, a user can efficiently find a desired image.

In order to achieve the object described above, an image display device according to the present invention is an image display device which plays back and displays a still image recorded by the photographic apparatus according to the eighth aspect of the present invention on a display device, the image display device comprising:

a device which acquires a still image recorded by the photographic apparatus and a measured period of time recorded in association with the still image;

a device which determines, based on the acquired amount of the displacement, an image switching effect to be used when displaying the still image; and

a device which plays back and displays the still image on the display device based on the determined image switching effect.

As described above, since the present invention is arranged to determine an image switching effect based on an amount of the displacement and to play back and display a still image based on the determined image switching effect, a user is now able to view an image while duplicating the aliveness and the sense of speed felt during photographing in a more realistic manner.

In order to achieve the object described above, a photographic system according to the present invention comprises: an imaging device that periodically drives an imaging element during a still image photographing mode to photograph a plurality of images and which performs actual photographing of a still image when a photographing instruction is input;

a subject detecting device that detects an arbitrary subject from an image photographed prior to the actual photographing;

a measuring device that measures a period of time over which the subject had been continuously detected by the subject detecting device;

a recording control device which records a still image taken by actual photographing and the measured period of time with associating the still image with the measured period of time on a recording device;

a device which reads a still image and the measured period of time recorded in association with the still image from the recording device;

a device which determines a display size of the still image based on the read measured period of time; and

a device which lists and displays a plurality of the acquired still images on a display device based on the determined display size.

In this manner, since the present invention is arranged so as to measure a period of time over which a subject had been continuously detected, record the measured period of time, and determine a display size of a still image based on the recorded measured period of time and to perform listing and display based on the determined display size, a user can efficiently find a desired image.

In order to achieve the object described above, a photographic system according to the present invention comprises: an imaging device that periodically drives an imaging element during a still image photographing mode to photograph a plurality of images and which performs actual photographing of a still image when a photographing instruction is input;

a subject detecting device that detects an arbitrary subject from an image photographed prior to the actual photographing;

a measuring device that measures a period of time over which the subject had been continuously detected by the subject detecting device;

a recording control device which records a still image taken by actual photographing and the measured period of time with associating the still image with the measured period of time on a recording device;

a device which reads a still image and the measured period of time recorded in association with the still image from the recording device;

a device which determines a display time of the still image based on the read measured period of time; and

a device which sequentially displays a plurality of the read still images on a display device based on the determined display time.

As described above, since the present invention is arranged so as to measure a period of time over which a subject had been continuously detected, record the measured period of time, determine a display time of a still image based on the recorded measured period of time, and sequentially display images based on the determined display time, a state is created in which the stronger the impression created by an image, the more prominent the image is to a user. Therefore, the user is now able to find a desired image in an efficient manner.

In order to achieve the object described above, a photographic control method according to the present invention comprises: an imaging step for periodically driving an imaging element during a still image photographing mode to photograph a plurality of images, and performing actual photographing of a still image when a photographing instruction is input;

a subject detecting step for detecting an arbitrary subject from an image photographed prior to the actual photographing;

a measuring step for measuring a period of time over which the subject had been continuously detected in the subject detecting step; and

an output step for outputting the measured period of time.

As described above, by measuring a period of time over which a subject had been continuously detected and outputting the measured period of time, a photographer is able to obtain an indicator of photographing. In order to achieve the object described above, an image display method according to the present invention is an image display method for playing back and displaying still images recorded by the photographic apparatus according to any of the third to eighth aspects of the present invention on a display device, the image display method comprising the steps of:

a step for acquiring a still image recorded by the photographic apparatus and a measured period of time recorded in association with the still image;

a step for determining a display size of the still image based on the acquired measured period of time; and

a step for listing and displaying a plurality of the acquired still images on the display device based on the determined display size.

In this manner, since the present invention is arranged so as to determine a display size of a still image based on a measured period of time and to perform listing and display based on the determined display size, a user can efficiently find a desired image.

In order to achieve the object described above, an image display method according to the present invention is an image display method for playing back and displaying still images recorded by the photographic apparatus according to any of the third to eighth aspects of the present invention on a display device, the image display method comprising the steps of:

a step for acquiring a still image recorded by the photographic apparatus and a measured period of time recorded in association with the still image;

a step for determining a display time of the still image based on the acquired measured period of time; and

a step for sequentially playing back and displaying a plurality of the acquired still images on the display device based on the determined display time.

In this manner, since the present invention is arranged so as to determine a display time of a still image based on a measured period of time and to sequentially play back and display images based on the determined display time, a user can efficiently find a desired image.

In order to achieve the object described above, a control method of a photographic system according to the present invention comprises: an imaging step for periodically driving an imaging element during a still image photographing mode to photograph a plurality of images, and performing actual photographing of a still image when a photographing instruction is input;

a subject detecting step for detecting an arbitrary subject from an image photographed prior to the actual photographing;

a measuring step for measuring a period of time over which the subject had been continuously detected in the subject detecting step;

a recording control step for recording a still image taken by actual photographing and the measured period of time with associating the still image and the measured period of time on a recording device;

a step for reading a still image and the measured period of time recorded in association with the still image from the recording device;

a step for determining a display size of the still image based on the read measured period of time; and

a step for listing and displaying a plurality of the acquired still images on a display device based on the determined display size.

In this manner, since the present invention is arranged so as to measure a period of time over which a subject had been continuously detected, record the measured period of time, and determine a display size of a still image based on the recorded measured period of time and to perform listing and display based on the determined display size, a user can efficiently find a desired image.

In order to achieve the object described above, a control method of a photographic system according to the present invention comprises: an imaging step for periodically driving an imaging element during a still image photographing mode to photograph a plurality of images, and performing actual photographing of a still image when a photographing instruction is input;

a subject detecting step for detecting an arbitrary subject from an image photographed prior to the actual photographing;

a measuring step for measuring a period of time over which the subject had been continuously detected in the subject detecting step;

a recording control step for recording a still image taken by actual photographing and the measured period of time with associating the still image and the measured period of time on a recording device;

a step for reading a still image and the measured period of time recorded in association with the still image from the recording device;

a step for determining a display time of the still image based on the read measured period of time; and

a step for sequentially displaying a plurality of the read still images on a display device based on the determined display time.

In this manner, since the present invention is arranged so as to measure a period of time over which a subject had been continuously detected, record the measured period of time, determine a display time of a still image based on the recorded measured period of time, and sequentially display images based on the determined display time, a user can efficiently find a desired image.

It is also possible to record a program for realizing the various devices that make up the photographic apparatus, the image display apparatus, and the photographic system according to the present invention through a computer on a recording medium such as a CD-ROM and a magnetic disk, and provide the program to a third party via the recording medium or provide a downloading service of the program via a communication line such as the Internet.

According to the present invention, by measuring a period of time over which a subject had been continuously detected and outputting the measured period of time, a photographer is now able to obtain an indicator of photographing. In addition, it is also possible to switch among photographic controls in accordance with the measured period of time.

Furthermore, by associating a still image taken by actual photographing with a measured period of time and recording the same, the search efficiency during playback of still images can be increased.

### BRIEF DESCRIPTION OF THE DRAWINGS

FIG. 1 is a diagram showing an example of an electric configuration of a digital camera 1 according to the present invention;

FIG. 2 is a flowchart showing operations of the digital camera 1 according to a first embodiment;

FIG. 3 is a diagram showing an example of a live view displayed on a display unit 31 of the digital camera 1;

FIG. 4 is a diagram showing photographed images taken by actual photographing in the example shown in FIG. 3, subject tracking times thereof, and post views displayed during actual photographing;

FIG. 5 is a diagram showing an example of an electric configuration of an image viewer 100 according to a second embodiment;

FIG. 6 is a flowchart showing operations of the image viewer 100 according to the second embodiment;

FIG. 7 is a diagram showing an example of images recorded on a recording medium 55, respective subject tracking times thereof, and respective degrees of memorability thereof;

FIG. 8 is a diagram showing an example of a thumbnail image list displayed on a display unit 57 of the image viewer 100;

FIG. 9 is a diagram showing timings of image switching when performing playback and display using an automatic frame advance function;

FIG. 10 is a diagram showing an example of an electric configuration of a digital camera 1 according to a third embodiment;

FIGS. 11A and 11B are diagrams showing displacements of the digital camera 1 during photographing;

FIGS. 12A and 12B are a flowchart showing operations of the digital camera 1 according to the third embodiment;

FIGS. 13A and 13B are diagrams showing an example of a live view displayed on a display unit 31 of the digital camera 1;

FIG. 14 is a flowchart showing operations of an image viewer 100 according to a fourth embodiment;

FIGS. 15A to 15C are diagrams showing image switching effects; and

FIG. 16 is a diagram showing an example of images recorded on a recording medium 55, camera displacements of the respective subjects, and camera movement speeds calculated from the camera displacements and tracking times.

### DETAILED DESCRIPTION OF THE PREFERRED EMBODIMENTS

Hereinafter, preferred embodiments of the present invention will be described.

### First Embodiment

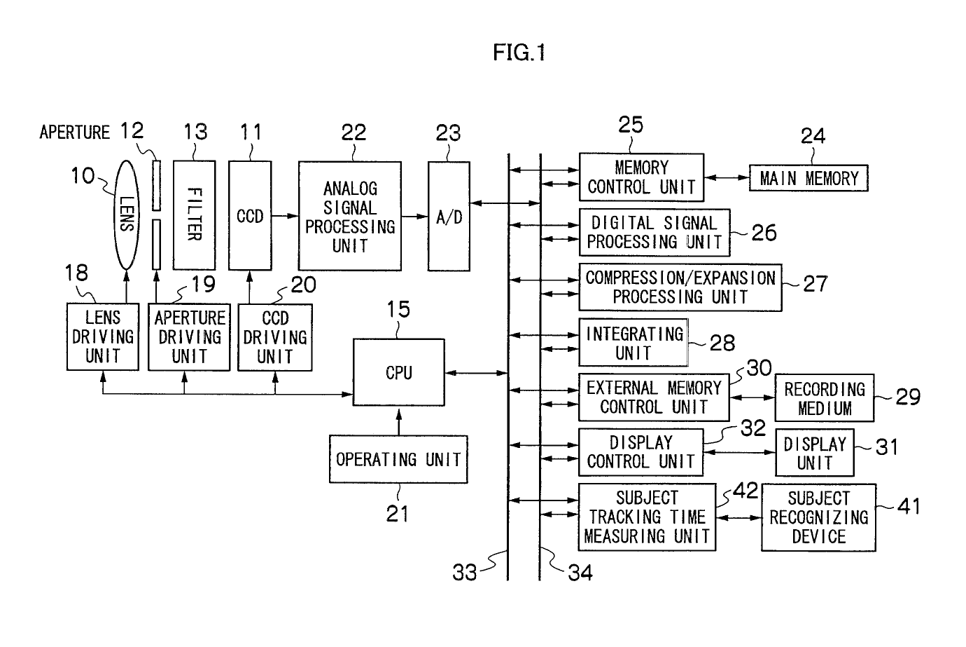

FIG. 1 is a diagram showing an example of an electric configuration of a digital camera 1 according to the present invention. As shown in the diagram, the digital camera 1 comprises a lens 10, a CCD 11, an aperture 12, an infrared cutoff filter 13, a CPU 15, a lens driving unit 18, an aperture driving unit 19, a CCD driving unit 20, an operating unit 21, an analog signal processing unit 22, an A/D converter 23, a main memory 24, a memory control unit 25, a digital signal processing unit 26, a compression/expansion processing unit 27, an integrating unit 28, a recording medium 29, an external memory control unit 30, a display unit 31, a display control unit 32, a control bus 33, a data bus 34, a subject recognizing device 41, a subject tracking time measuring unit 42, and the like.

The respective units operate under the control of the CPU 15. The CPU 15 controls the respective units of the digital camera 1 based on input from the operating unit 21 by executing predetermined control programs.

The digital camera 1 includes a ROM, not shown, on which are recorded control programs to be executed by the CPU 15 as well as various data and the like necessary for control. The CPU 15 controls the respective units of the digital camera 1 by reading out and sequentially executing the control programs recorded on the ROM.

The main memory 24 is constituted by an SDRAM and is used as a program execution processing area as well as a temporary storage area of image data and the like and as various work areas.

The operating unit 21 includes a power button, a shutter release button, a photographing mode/playback mode switching switch, and the like, which are not shown, and outputs signals in accordance with the respective operations to the CPU 15.

The lens 10 includes a zoom lens and a focusing lens, which are not shown, and is driven by the lens driving unit 18 to perform zooming and focusing.

The aperture 12 is for adjusting the amount of subject light passing through the lens 10 and which reaches a light receiving surface of the CCD 11. The aperture driving unit 19 controls the opening size of the aperture 12 according to an instruction from the CPU 15 and adjusts the aperture 12 so as to attain an appropriate exposure amount.

The infrared cutoff filter 13 functions to prevent ghosts and fogging due to infrared light from occurring in a photographed image by cutting off infrared light of a particular wavelength from the subject light passed through the aperture 12.

The CCD 11 is disposed at a stage subsequent to the infrared cutoff filter 13, and receives the subject light passing through the lens 10.

A large number of light receiving elements, not shown, are two-dimensionally arranged on the light receiving surface of the CCD 11. Red (R), green (G), and blue (B) primary color filters, not shown, are arranged in a predetermined array structure in correspondence with the respective light receiving elements. The subject light forming an image on the light receiving surface is converted into electric signals by the respective light receiving elements and the electric signals are subsequently accumulated.

Electric signals accumulated in each light receiving element are read out to a vertical transfer path, not shown. The vertical transfer path synchronizes the signals to a clock supplied from the CCD driving unit 20 and transfers the synchronized signals one line at a time to a horizontal transfer path, not shown. Furthermore, the horizontal transfer path synchronizes one line's worth of signals transferred from the vertical transfer path to a clock supplied from the CCD driving unit 20, and outputs the synchronized signals to the analog signal processing unit 22.

Output of an image signal commences when the digital camera 1 is set to the photographing mode. In other words, when the digital camera 1 is set to the photographing mode, output of an image signal commences to display a live view on the display unit 31. The output of the image signal for a live view is temporarily suspended when an instruction for actual photographing is issued, and recommences upon the conclusion of actual photographing. Moreover, upon conclusion of actual photographing, a photographed image taken by actual photographing is displayed on the display unit 31 for a certain amount of time (post view). By checking the post view, the user is able to verify whether or not the photographed image had been taken appropriately.

The analog signal processing unit 22 is configured so as to include a correlated double sampling circuit (CDS), a clamp processing circuit, and an automatic gain control circuit (AGC) which are not shown.

The CDS removes noise included in an image signal. The clamp processing circuit performs processing for removing a dark current component. Furthermore, the AGC amplifies an image signal from which a dark current component has been removed with a predetermined gain in accordance with a set photographic sensitivity (ISO sensitivity).

An analog image signal subjected to predetermined signal processing by the analog signal processing unit 22 is converted at the A/D converter 23 into a digital image signal having a tone width of a predetermined number of bits. The image signal is so-called RAW data and contains a tonal value indicating R, G, and B concentrations for each pixel. The digital image signal is stored in the main memory 24 via the data bus 34 and the memory control unit 25.

Connected to the control bus 33 and the data bus 34 in addition to the memory control unit 25 described above are the digital signal processing unit 26, the compression/expansion processing unit 27, the integrating unit 28, the external memory control unit 30, the display control unit 32, the subject tracking time measuring unit 42, and the like. The respective units are arranged so as to be capable of transmitting and receiving information among each other via the data bus 34 based on a control signal of the control bus 33.

The digital signal processing unit 26 performs predetermined signal processing on image signals of the respective colors of R, G, and B stored in the main memory 24, and generates an image signal (Y/C signal) made up of a luminance signal Y and color difference signals Cr and Cb.

Pursuant to a compression command from the CPU 15, the compression/expansion processing unit 27 performs compression processing under a predetermined format (e.g., JPEG) on an input image signal (Y/C signal) made up of a luminance signal Y and color difference signals Cr and Cb to generate compressed image data. In addition, pursuant to an expansion command from the CPU 15, the compression/expansion processing unit 27 performs expansion processing under a predetermined format on input compressed image data to generate non-compressed image data.

Pursuant to a command from the CPU 15, the integrating unit 28 loads R, G, and B image signals stored in the main memory 24 and calculates an integrated value necessary for AE control. The CPU 15 calculates a luminance value from the integrated value and then obtains an exposure value from the luminance value. In addition, the CPU 15 determines an aperture value and a shutter speed from the exposure value according to a predetermined program diagram.

Pursuant to a command from the CPU 15, the external memory control unit 30 controls read/write of data with respect to the recording medium 29. The recording medium 29 may either be attachable/detachable to/from a main body of the digital camera 1 such as the case of a memory card, or built into the main body of the digital camera 1. When arranging the recording medium 29 so as to be attachable/detachable to/from the main body of the digital camera 1, a card slot is to be provided on the main body, whereby the recording medium 29 is used by mounting the same to the card slot.

Pursuant to a command from the CPU 15, the display control unit 32 controls displaying on the display unit 31. The display unit 31 is a liquid crystal monitor that can be used as an electronic view finder to display moving images (live views). The display unit 31 is also capable of displaying photographed images prior to recording (post view images), playback images read from the recording medium 29, and the like.

The subject recognizing device 41 detects a subject in a photographed image based on image similarity from the R, G, and B image signals of the respective frames of a live view stored in the main memory 24. The method of recognizing a subject is not limited to the above, and a subject may be detected using, for example, contour extraction processing or human face detection processing. The subject tracking time measuring unit 42 measures a period of time over which a subject is detected by the subject recognizing device 41.

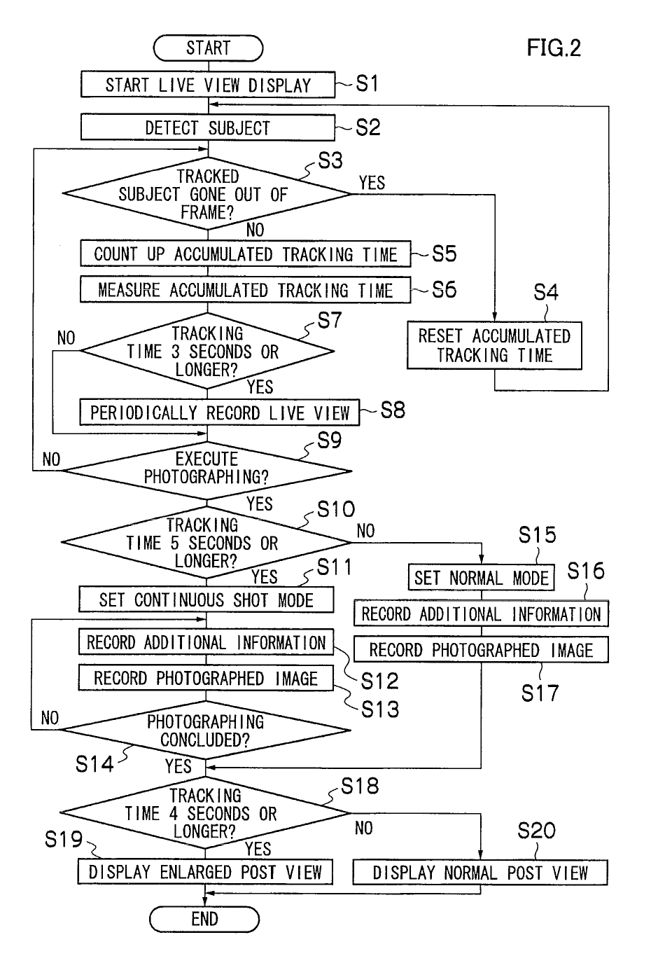

Operations of the digital camera 1 according to the first embodiment will now be described with reference to FIG. 2. The digital camera 1 according to the present embodiment associates, as additional information, a period of time over which a photographed subject had been tracked with a photographed image, and records the same.

With the digital camera 1, when power is turned on via the operating unit 21 and the photographing mode is set, output of image signals from the CCD 11 is started and the digital camera 1 starts displaying a live view on the display unit 31 (step S1). A user can decide on a composition while viewing the live view displayed on the display unit 31.

The subject recognizing device 41 detects a subject in the live view from the image signals of the live view (step S2). As described earlier, the subject recognizing device 41 detects a subject using a similarity of the image of each frame of a live view. When the subject recognizing device 41 detects a subject, the subject tracking time measuring unit 42 starts measurement of a period of time during which the detected subject exists in the image signals (tracking time).

Moreover, continuous shots of a still image may be photographed instead of a live view, whereby the subject recognizing device 41 may detect a subject from the photographed continuous shots. In this case, displaying the continuous shots on the display unit 31 instead of a live view shall suffice.

Next, a judgment is made on whether or not the detected subject has gone out of frame or, in other words, whether or not the detected subject exists in the image signals (step S3). If the subject has gone out of frame, the subject tracking time measuring unit 42 resets the accumulated tracking time (step S4), and the routine returns to step S2. If the subject has not gone out of frame, the subject tracking time measuring unit 42 continuously counts up the measurement of the tracking time (step S5), and measures the accumulated tracking time (step S6). The tracking time measured by the subject tracking time measuring unit 42 may be displayed together with the live view on the display unit 31.

Operations performed in steps S1 to S6 will now be described with reference to

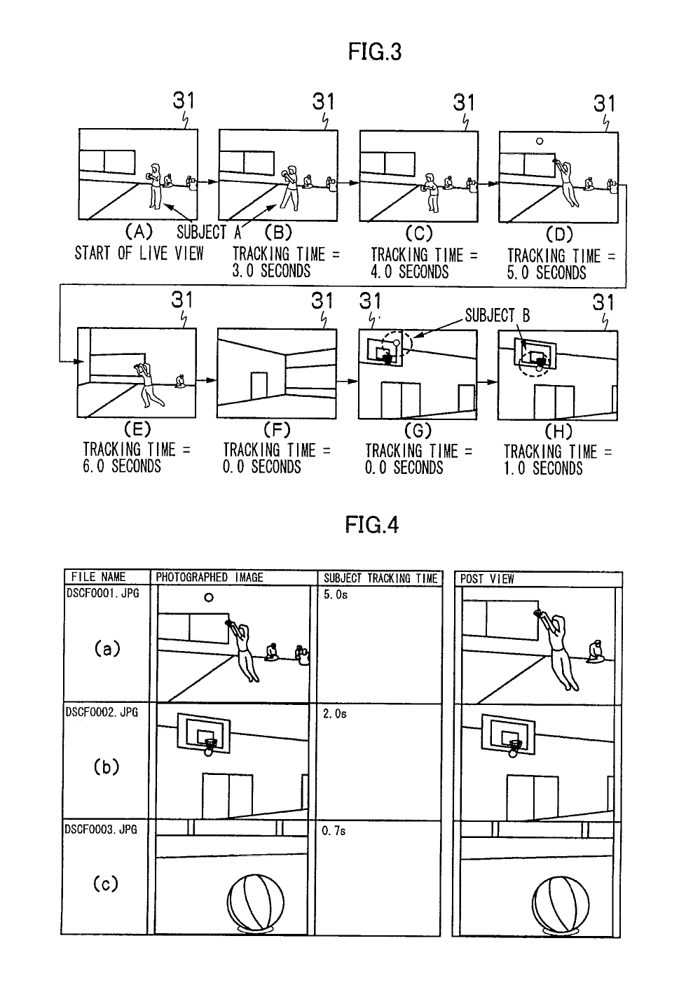

FIG. 3. FIG. 3 is a diagram showing examples of live views displayed on the display unit 31 of the digital camera 1.

(A) of FIG. 3 shows a display on the display unit 31 upon start of output of a live view. The subject recognizing device 41 detects a person at the center of the image (subject A) as a subject from the image signals of the live view. The subject tracking time measuring unit 42 measures a period of time over which the subject A has been detected.

(B) to (E) of FIG. 3 show displays on the display unit 31 when 3 seconds, 4 seconds, 5 seconds, and 6 seconds have respectively elapsed from (A) of FIG. 3. During this period, the subject recognizing device 41 is continuously detecting the subject A as a subject, and the subject tracking time measuring unit 42 measures the period thereof.

(F) of FIG. 3 shows a display on the display unit 31 when 1 second has elapsed from (E) of FIG. 3. In (F) of FIG. 3, since the composition has been changed from the previous composition and the subject A has gone out of frame, the subject recognizing device 41 does not detect the subject A. Therefore, the subject tracking time measuring unit 42 resets the measured period of time.

(G) of FIG. 3 shows a display on the display unit 31 when 1 second has elapsed from (F) of FIG. 3. The subject recognizing device 41 detects a ball at the top left of the image (subject B) as a subject from the image signals of the live view. The subject tracking time measuring unit 42 measures a period of time over which the subject B is detected.

(H) of FIG. 3 shows a display on the display unit 31 when 1 second has elapsed from (G) of FIG. 3. During this period, the subject recognizing device 41 is continuously detecting the subject B as a subject, and the subject tracking time measuring unit 42 measures the period thereof.

As shown, the subject recognizing device 41 detects a subject and the subject tracking time measuring unit 42 measures a period of time during which the subject is detected. Moreover, when the subject recognizing device 41 detects a plurality of subjects, the subject tracking time measuring unit 42 may either measure a tracking time for each of the detected subjects, or set the largest subject or the subject nearest to the digital camera 1 as a primary subject and measure a tracking time only for the primary subject.

Next, a judgment is made on whether or not the period of time measured by the subject tracking time measuring unit 42 is equal to or greater than 3 seconds (step S7). If so, a live view is recorded every second (step S8). A live view is recorded by the external memory control unit 30 onto the recording medium 29. A live view need not necessarily be recorded every second, and may be recorded every given number of seconds as long as such recording is performed periodically. In addition, a configuration is also possible in which the number of seconds can be set by the user. In the example shown in (A) to (H) of FIG. 3, live views subsequent to (B) of FIG. 3 are recorded onto the recording medium 29 every second.

When the measured period of time is equal to or greater than 3 seconds and recording of a live view is commenced, the routine proceeds to step S9 to judge whether or not actual photographing has been executed (step S9). The routine similarly proceeds to step S9 when the period of time measured by the subject tracking time measuring unit 42 is less than 3 seconds.

Execution of actual photographing is performed by operating a shutter release button, not shown, of the operating unit 21. When the shutter release button has not been operated, the routine returns to step S3 to repeat the same processing.

When the shutter release button is operated, a judgment is made on whether or not the period of time measured by the subject tracking time measuring unit 42 is equal to or greater than 5 seconds (step S10). When the measured period of time is equal to or greater than 5 seconds, the continuous shot mode is set (step 11), and if not, the normal mode is set (step S15). The normal mode is a mode in which a single image is photographed by one operation of the shutter release button, and the continuous shot mode is a mode in which a plurality of images is continuously photographed while the shutter release button is being pressed. The continuous shot mode may be a mode in which a predetermined plurality of images is photographed by one operation of the shutter release button.

When the continuous shot mode is set, photographed images are recorded and, at the same time, a tracking time measured by the subject tracking time measuring unit 42 is recorded as additional information (steps S12 and S13). Subsequently, steps S12 and S13 are repeated until the shutter release button is released (step S14). The same tracking time is recorded with respect to all photographed images taken by continuous shooting.

When the normal mode is set, photographed images are recorded and, at the same time, a tracking time measured by the subject tracking time measuring unit 42 is recorded as additional information (steps S16 and S17). Actual photographing is then concluded.

At this point, while the tracking time is recorded as Exif information of a photographed image, the tracking time may be recorded in another format as long as the tracking time is associated with the photographed image.

Upon conclusion of actual photographing, a judgment is made on whether or not the tracking time measured by the subject tracking time measuring unit 42 (the tracking time recorded as additional information) is equal to or greater than 4 seconds (step S18). If not, post view display is performed so that the photographed image is displayed as-is (step S20). If so, post view display is performed by automatically adjusting the display position and magnification so that the tracked subject is enlarged and displayed across the entire screen of the display unit 31 (step S19).

FIG. 4 is a diagram showing photographed images taken by actual photographing in FIG. 3, subject tracking times, and post views displayed during actual photographing.

File DSCF0001.JPG is a photographed image taken by actual photographing at the timing of (D) of FIG. 3. The tracking time recorded as additional information is 5 seconds and therefore satisfies the condition of 4 seconds or more. Accordingly, a post view is displayed so as to enlarge the subject A detected by the subject recognizing device 41. The photographed image and the enlarged image of subject A may also be displayed side by side. In addition, since the condition of 5 seconds or more is satisfied, a plurality of images other than the image of (a) of FIG. 4 is taken in the continuous shot mode. Therefore, post views may be displayed side by side for all images taken by continuous shooting.

File DSCF0002.JPG is a photographed image taken by actual photographing at the timing of (H) of FIG. 3. The tracking time recorded as additional information is 1 second and therefore does not satisfy the condition of 4 seconds or more. Accordingly, post view display is performed so as to display the photographed image as-is.

File DSCF0003.JPG is a photographed image taken by actual photographing at a timing after (H) of FIG. 3. The tracking time recorded as additional information is 0.7 seconds and therefore does not satisfy the condition of 4 seconds or more. Accordingly, in the same manner as (b) of FIG. 4, post view display is performed so as to display the photographed image as-is.

Moreover, when actual photographing is performed at the timing of (H) of FIG. 3 instead of the timing of (D) of FIG. 3, the subject A is determined to have gone out of frame in step S3 at the timing of (F) of FIG. 3 and the tracking time is reset in step S4. Therefore, only the tracking time of the subject B is recorded as additional information with an image taken by actual photographing at the timing of (H) of FIG. 3. However, when resetting the tracking time in step S4, the tracking time of the subject A may be cached in the main memory 24 so that the tracking time of the subject A is also recorded after actual photographing in the recording medium 29 as Exif information of the photographed image. In this case, since the tracking time of the subject A is 6 seconds counted from the timing of (A) of FIG. 3 to the timing of (E) of FIG. 3, 6 seconds is recorded as the tracking time of a subject not existing in the image in addition to the tracking time of the subject B that is 1 second.

As described, the digital camera 1 according to the first embodiment measures a period of time over which a photographed subject had been tracked, and records the tracking time in the recording medium 29 in association with a photographed image as additional information. The display unit 31 may be used as the output destination of the measured tracking time instead of the recording medium 29. In addition, since live views are arranged so as to be periodically recorded when the measured tracking time exceeds a predetermined period of time before actual photographing, the conditions upon photographing can be retained as a record in the recording medium 29 even when a photo opportunity is missed. Furthermore, since the mode is arranged so as to be switched to the continuous shot mode during actual photographing when the measured tracking time exceeds a predetermined period of time during actual photographing, photographing can be performed without missing photo opportunities.

Moreover, since display of post views is arranged so as to be changed in accordance with tracking time, the user can now check how well a photographed subject has been captured. The period of time to be used as the threshold for switching is not limited to that of the present invention, and may either be arbitrarily decided or be arranged so as to be settable by the user.

While an example in which the present invention is realized using the digital camera 1 has been described in the present embodiment, the present invention can also be realized with an apparatus including an imaging device such as a camera-equipped mobile telephone. In addition, the present invention can also be realized by having a personal computer or the like including an imaging device execute a program including the same processing flow as that shown in FIG. 2.

### Second Embodiment

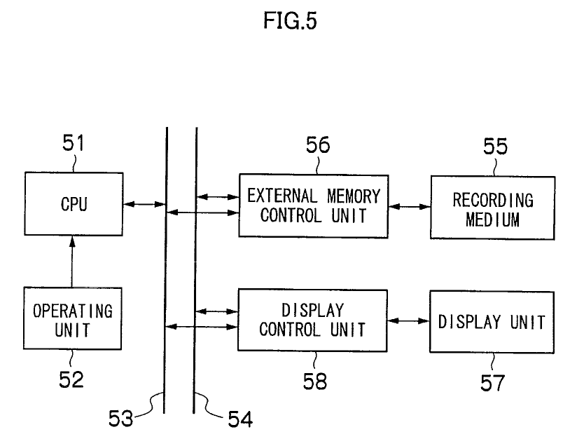

FIG. 5 is a diagram showing an example of an electric configuration of an image viewer 100 according to a second embodiment. As shown in the diagram, the image viewer 100 comprises a CPU 51, an operating unit 52, a control bus 53, a data bus 54, a recording medium 55, an external memory control unit 56, a display unit 57, a display control unit 58, and the like.

The respective units operate under the control of the CPU 51. The CPU 51 controls the respective units of the image viewer based on input from the operating unit 52 by executing predetermined control programs. Pursuant to a command from the CPU 51, the external memory control unit 56 reads out an image recorded on the recording medium 55. The display control unit 58 displays the image on the display unit 57 in accordance with a command from the CPU 51. The display unit 57 is a liquid crystal monitor capable of displaying playback images and the like.

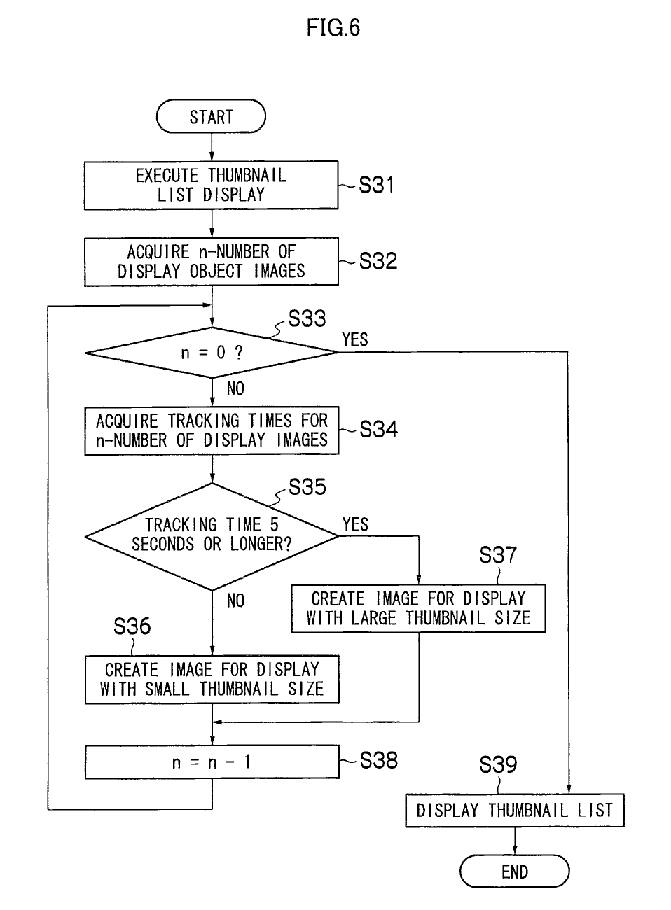

Next, operations of the image viewer 100 according to the second embodiment will now be described with reference to FIG. 6. The image viewer 100 according to the present embodiment changes playback display methods in accordance with the tracking time recorded as additional information.

First, a user operates the operating unit 52 to list and display thumbnail images (step S31). The external memory control unit 56 acquires n-number of images to become objects of listing and displaying from images recorded on the recording medium 55 (step S32).

The CPU 51 judges whether n is 0 or not (step S33), and if not, acquires the tracking time of the nth image via the external memory control unit 56 (step S34). The tracking time of the image is to be read from Exif information if recorded as Exif information, and if recorded in association with the image in another format, reading out such information shall suffice.

Next, a judgment is made on whether or not the tracking time of the read image is equal to or greater than 5 seconds (step S35). If not, the thumbnail size is set to small and a display image is created (step S36). If the tracking time is equal to or greater than 5 seconds, the thumbnail size is set to large and a display image is created (step S37).

When a thumbnail image is recorded as Exif information, the size of the thumbnail image is set as small. When the thumbnail size is large, the thumbnail image in the Exif information is enlarged.

Once the thumbnail size of the nth image is decided, n is decremented (step S38) and the routine returns to step S33 to repeat the same processing. When n becomes 0, thumbnail images are listed and displayed in the thumbnail size determined in steps S36 and S37 (step S39), and the processing is concluded.

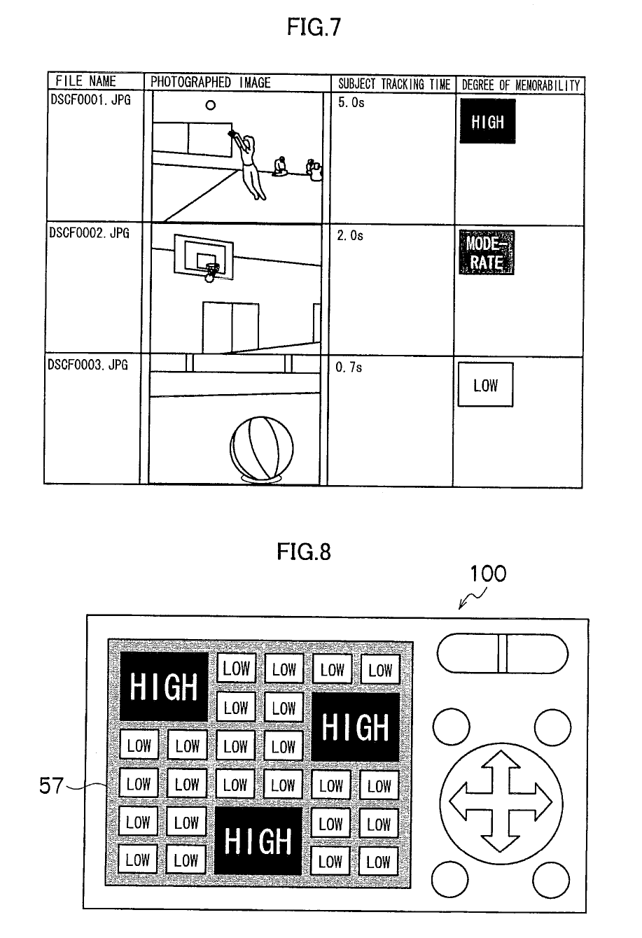

FIG. 7 is a diagram showing an example of images recorded on the recording medium 55, respective subject tracking times thereof, and respective degrees of memorability thereof. As shown in the diagram, the image of file DSCF0001.JPG has a subject tracking time of 5 seconds, the image of file DSCF0002.JPG has a subject tracking time of 2 second, and the image of file DSCF0003.JPG has a subject tracking time of 0.7 seconds.

It is likely that the image of file DSCF0001.JPG with a long subject tracking time is memorable to the user and, conversely, the image of file DSCF0003.JPG with a short subject tracking time is not as memorable to the user. Therefore, as shown in FIG. 8, by displaying an image with a long subject tracking time at a larger thumbnail size, the large-displayed image functions as a bookmark. Consequently, the user can roughly recollect the circumstances during photographing just by looking at the large displayed image and quickly determine where a searched image is. While the example of FIG. 8 shows the large thumbnail size to be four times as large as the small thumbnail size, the size ratio may be decided as appropriate. In addition, as a digest, only images with long subject tracking times may be displayed.

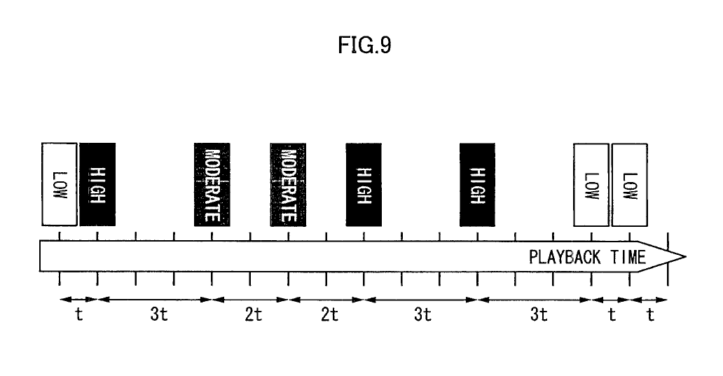

Furthermore, as a modification of the present embodiment, as shown in FIG. 9, the timing at which images are switched may be adjusted depending on the length of subject tracking times when performing playback and display using automatic frame advance functions such as slide show display and high-speed playback display. In FIG. 9, the abscissa represents time and indicates the switching timings of the respective images. In the example shown in FIG. 9, playback time is changed in three stages of t, 2t, and 3t depending on the subject tracking times. By displaying images in this manner, a desired image is not missed even during automatic frame advance. In addition, a period of time for performing operations such as enlarged display or print specification can be secured. Furthermore, in the same manner as in the case of list display, as a digest, only images with long subject tracking times may be displayed.

Moreover, subject tracking times may be used when selecting a representative image of each photographing date with respect to a calendar function that displays images for respective photographing dates or when selecting a representative image of each folder with respect to an application that manages files and folders. For example, by selecting an image with the longest subject tracking time, the image that is most memorable to the user can be selected.

As described above, it is likely that the longer the subject tracking time of a subject in an image, the more memorable the image. Therefore, by presenting images that are more memorable so as to be more noticeable to the user and using the images as landmarks during a search, the user can find a desired image with greater efficiency.

Although image playback and display is performed using the image viewer 100 in the present embodiment, similar image playback and display may be performed in the playback mode of the digital camera 1 according to the first embodiment. In this case, the list of thumbnail images recorded in the recording medium 29 is displayed on the display unit 31 of the digital camera 1.

Moreover, image playback and display can also be realized using a personal computer with a built-in image playback application program.

### Third Embodiment

A digital camera 1 according to a third embodiment associates, with a photographed image, a period of time over which a photographed subject had been tracked as well as the displacement of the digital camera 1 over the period of time of tracking, as additional information, and records the same.

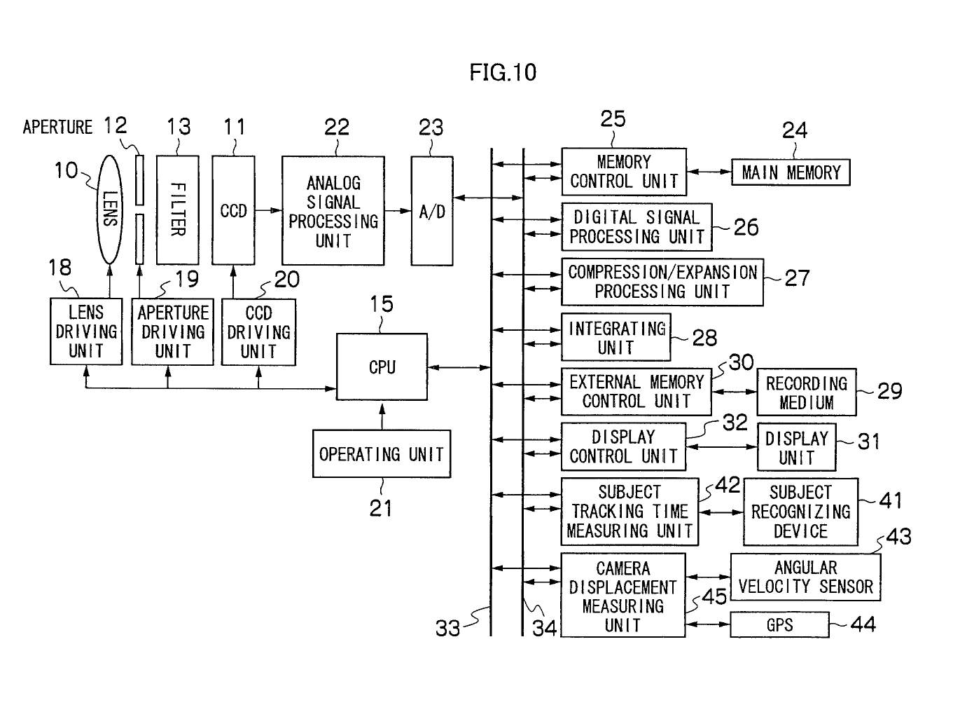

FIG. 10 is a diagram showing an example of an electric configuration of a digital camera 1 according to the present embodiment. Parts in common with FIG. 1 are assigned the same reference numerals and detailed descriptions thereof shall be omitted. The digital camera 1 according to the present embodiment differs from the digital camera 1 according to the first embodiment shown in FIG. 1 in that the digital camera 1 according to the present embodiment includes an angular velocity sensor 43, a GPS 44, and a camera displacement measuring unit 45.

The angular velocity sensor 43 detects a three-dimensional angular velocity from inertia force (Coriolis force), and measures the direction of the lens of the main body of the digital camera 1. Methods of detecting an angular velocity may include those using optical interference. The GPS 44 receives GPS radio waves from a GPS satellite to pinpoint a current position of the digital camera 1.

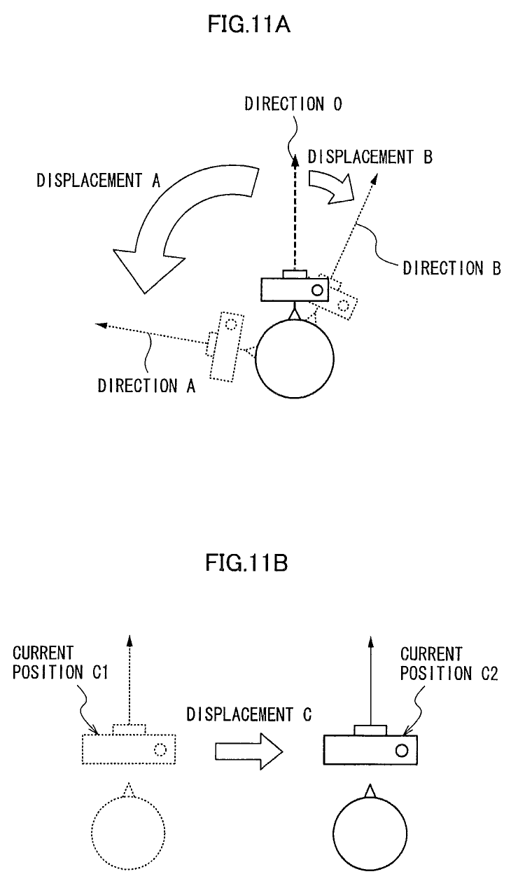

The camera displacement measuring unit 45 calculates a displacement A or a displacement B from an output of the angular velocity sensor 43 as an displacement angle shown in FIG. 11A. In addition, a displacement C is calculated from an output of the GPS 44 as a displacement distance shown in FIG. 11B.

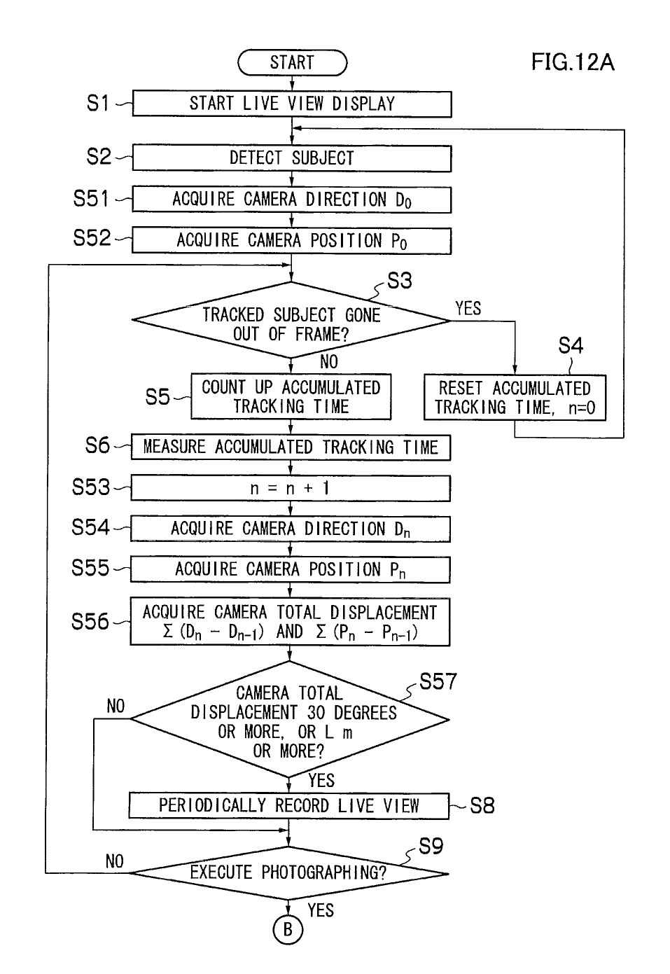

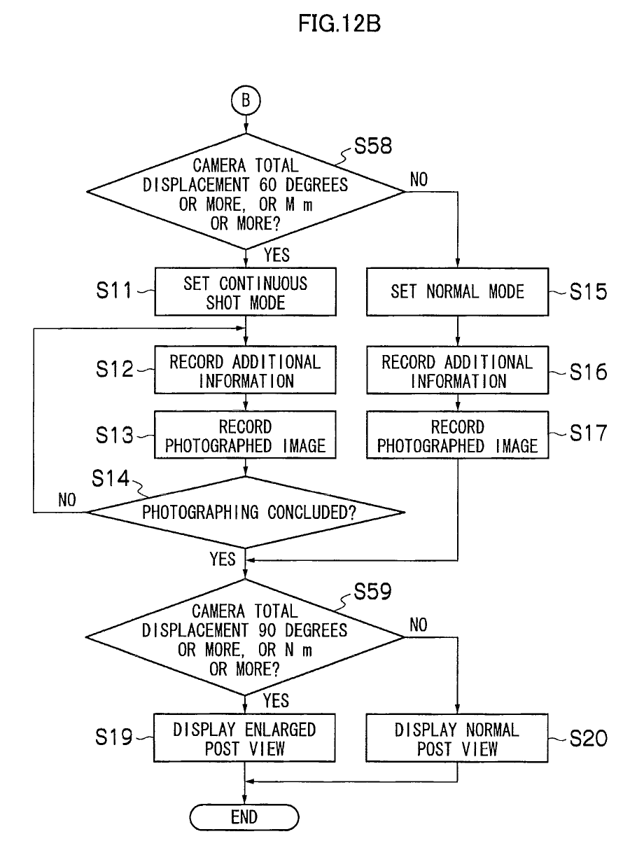

Next, operations of the digital camera 1 according to the present embodiment will be described with reference to FIGS. 12A and 12B. Parts in common with FIG. 2 are assigned the same reference numerals and detailed descriptions thereof shall be omitted.

First, the digital camera 1 commences display of a live view on the display unit 31 (step S1). The subject recognizing device 41 detects a subject in the live view from the image signals of the live view (step S2). When the subject recognizing device 41 detects a subject, the subject tracking time measuring unit 42 starts measurement of a period of time during which the detected subject exists in the image signals.

In addition, the angular velocity sensor 43 acquires a camera direction D₀ (step S51) and the GPS 44 acquires a camera position P₀ (step S52).

When a subject is detected, a judgment is made on whether or not the detected subject has gone out of frame (step S3). When the detected subject has gone out of frame, the subject tracking time measuring unit 42 resets the accumulated tracking time and clears a variable n (step S4), to be described later, and the routine returns to step S2. When the detected subject has not gone out of frame, the subject tracking time measuring unit 42 continues time measurement (step S6).

Next, the variable n is incremented (step S53), the angular velocity sensor 43 acquires a camera direction Dₙ (step S54), and the GPS 44 acquires a camera position Pₙ (step S55). Furthermore, the camera displacement measuring unit 45 calculates a summation of displacement angles (Σ(Dₙ−Dₙ₋₁)) and a summation of displacement distances (Σ(Pₙ−Pₙ₋₁)) as a total displacement of the camera.

With respect to the calculated total displacement of the camera, a judgment is made either on whether or not the summation of the displacement angles is equal to or greater than 30 degrees or whether or not the summation of the displacement distances is equal to or greater than L m (step S57). If even one of the above is applicable, a live view is recorded every second (step S8). A live view is recorded by the external memory control unit 30 onto the recording medium 29. In consideration of the risk of missing photo opportunities when photographing a subject whose displacement is large, a live view is arranged so as to be periodically recorded when the total displacement is significant in anticipation of missing photo opportunities.

Next, a judgment is made on whether or not the shutter release button has been operated (step S9), and if not, the routine returns to step S3 to repeat the same processing.

When the shutter release button has been operated, a judgment is made either on whether or not the summation of the displacement angles is equal to or greater than 60 degrees or whether or not the summation of the displacement distances is equal to or greater than M m (step S58). If even one of the above is applicable, the continuous shot mode is set (step 11), and if neither is applicable, the normal mode is set (step S15).

When the continuous shot mode is set, a photographed image is recorded and, at the same time, a tracking time measured by the subject tracking time measuring unit 42 as well as the summation of displacement angles and the summation of displacement distances are recorded as additional information (steps S12 and S13). Steps S12 and S13 are repeated until the shutter release button is released (step S14).

When the normal mode is set, a photographed image is recorded and, at the same time, a tracking time measured by the subject tracking time measuring unit 42 as well as the summation of displacement angles and the summation of displacement distances are recorded as additional information (steps S16 and S17). Actual photographing is then concluded.

Upon conclusion of photographing, a judgment is made either on whether or not the summation of the displacement angles is equal to or greater than 30 degrees or whether or not the summation of the displacement distances is equal to or greater than N m (step S59). When neither of the above is applicable, post view display is performed so that the photographed image is displayed as-is (step S20). If even one of the above is applicable, post view display is performed so that the detected subject is enlarged and displayed (step S19).

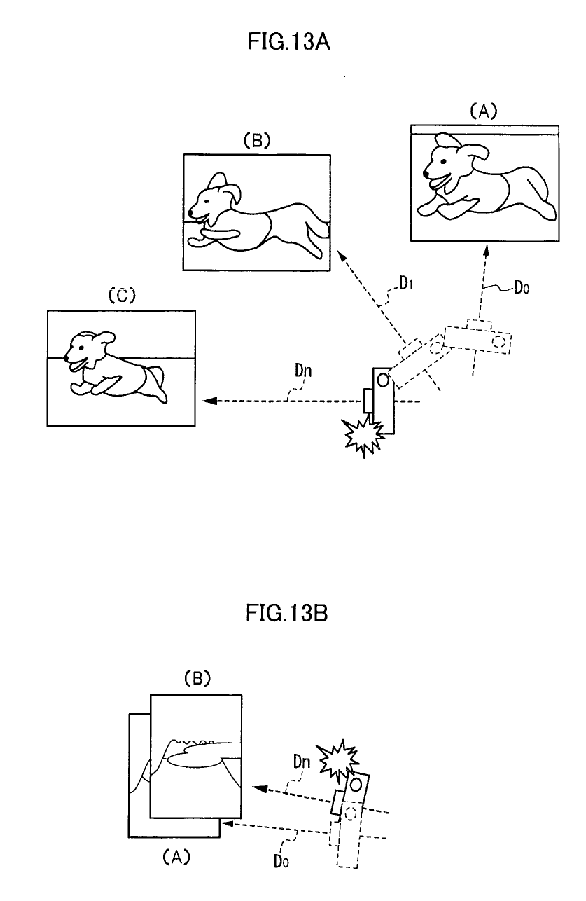

FIGS. 13A and 13B are diagrams showing an example of a live view displayed on the display unit 31 of the digital camera 1.

FIG. 13A shows a live view (A) displayed on the display unit 31 when live view display is commenced and a direction D₀ of the lens of the digital camera 1, a live view (B) and a direction D₁ of the lens of the digital camera 1, and a photographed image (C) taken by actual photographing and a direction Dₙ, of the lens of the digital camera 1. In this example, the summation of the displacement angles is 95 degrees and is recorded as additional information of the photographed image (C) together with the tracking time and the displacement distance.

In addition, FIG. 13B shows a live view (A) displayed on the display unit 31 when live view display is commenced and a direction D₀ of the lens of the digital camera 1, and a photographed image (B) taken by actual photographing and a direction Dn of the lens of the digital camera 1. In this example, the summation of the displacement angles is 15 degrees and is recorded as additional information of the photographed image (B) together with the tracking time and the displacement distance.

The present embodiment is arranged so that the continuous shot mode is set in cases where the summation of the angles of the displacement or the summation of the displacement distances of the digital camera 1 is significant during actual photographing. Alternatively, in such cases, the shutter speed may be switched to high speed, the photographic sensitivity (ISO sensitivity) may be set to high, or the compensation amount of a camera-shake compensation function may be increased. In addition, a speed of the movement of a subject may alternatively be calculated from the displacement and the tracking time, whereby the switching operations described above may be performed when the subject is moving at high speed.

Furthermore, in the same manner as the first embodiment, when resetting the tracking time in step S4, the tracking time of a subject that has gone out of frame and the camera displacement may be cached in the main memory 24, whereby the tracking time of the subject that has gone out of frame and the camera displacement are also recorded after actual photographing in the recording medium 29 as Exif information of the photographed image.

Moreover, in the same manner as the first embodiment, the present invention can also be realized by having a personal computer or the like including an imaging device, an angular velocity sensor, and the like execute a program including the same processing flow as that shown in FIGS. 12A and 12B.

### Fourth Embodiment

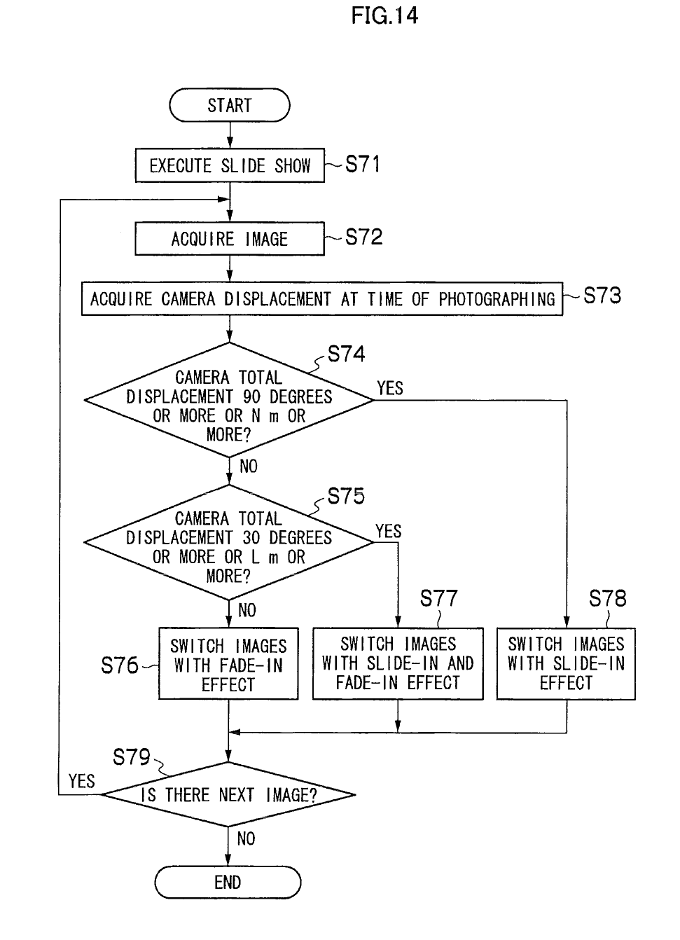

Operations of an image viewer 100 according to a fourth embodiment will now be described with reference to FIG. 14. The electric configuration of the image viewer 100 according to the present embodiment is the same as the image viewer 100 according to the second embodiment shown in FIG. 5. The image viewer 100 according to the present embodiment changes image switching effects during a slide show depending on the displacement recorded with a photographed image as additional information.

First, a user operates the operating unit 52 to execute a slide show of photographed images (step S71). A slide show refers to a display method in which a plurality of photographed images is switched every predetermined amount of time to be played back and displayed. The external memory control unit 56 reads out the oldest image from the images recorded on the recording medium 55 (step S72), and also acquires a displacement recorded as additional information (step S73).

The CPU 51 judges whether or not the acquired displacement is equal to or greater than 90 degrees or equal to or greater than N m (step S74). If even one of the above is applicable, image switching is performed with a slide-in effect (step S78). If neither is applicable, a judgment is made on whether or not the acquired displacement is equal to or greater than 30 degrees or equal to or greater than L m (step S75). If even one of the above is applicable, image switching is performed with a fade-in and slide-in effect (step S77). If neither is applicable, image switching is performed with a fade-in effect (step S76).

Once image switching is concluded, a judgment is made on whether or not there are images not yet displayed (step S79). When there are images not yet displayed, the routine returns to step S72 to read out the oldest image from the images not yet displayed and the same processing is repeated.

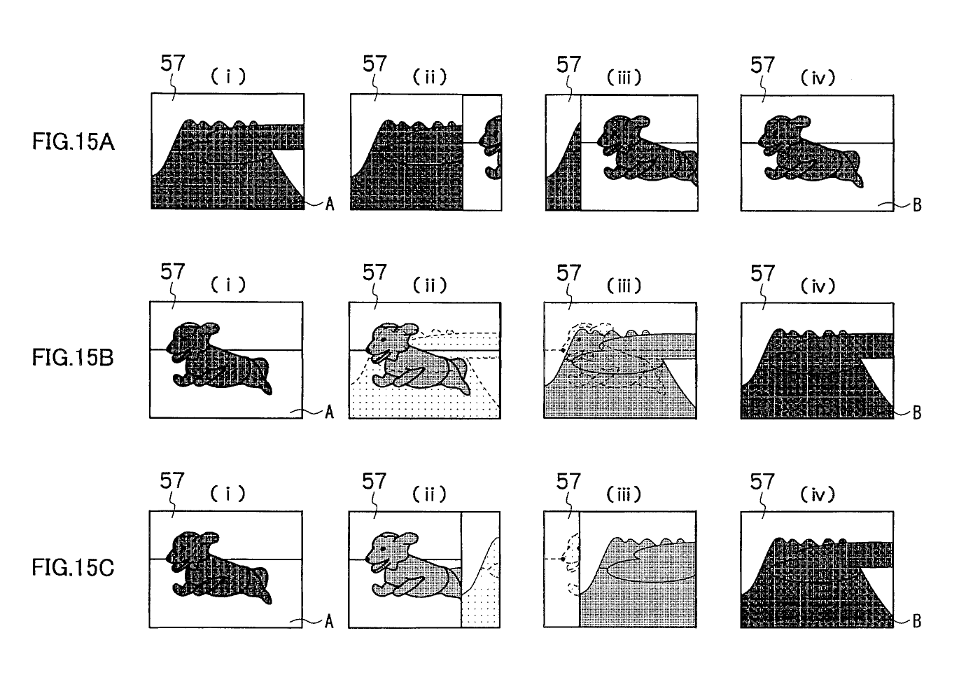

FIGS. 15A and 15B are diagrams showing image switching effects displayed on the display unit 57 of the image viewer 100 during execution of a slide show. FIG. 15A shows a slide-in effect, FIG. 15B a fade-in effect, and FIG. 15C a fade-in and slide-in effect. Each case shows image switching from a state in which an image A depicted in reference character (i) is displayed to an image B.

With the slide-in effect shown in FIG. 15A, images are switched with a sliding motion as though the image B is inserted from the right side of the display unit 57. Therefore, an effect expressing a sense of speed is obtained. In comparison, with the fade-in effect shown in FIG. 15B, the image A is displayed so as to gradually fade out while the image B is displayed so as to gradually fade in, and the image A is ultimately replaced by the image B. As shown, the fade-in effect provides a subdued expression. With the fade-in and slide-in effect shown in FIG. 15C, images are switched with an effect that combines the two aforementioned effects.

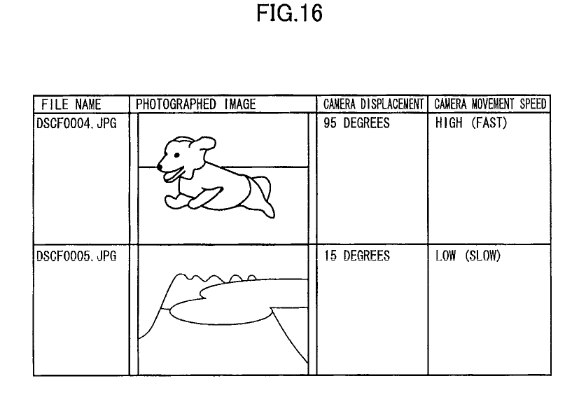

FIG. 16 is a diagram showing an example of images recorded on the recording medium 55, camera displacements of the respective subjects, and camera movement speeds calculated from the camera displacements and the tracking times. As shown in the diagram, with the image of file DSCF0004.JPG, the displacement angle of the camera is 95 degrees and the camera movement speed is high. In addition, with the image of file DSCF0005.JPG, the displacement angle of the camera is 15 degrees and the camera movement speed is low.

Therefore, when displaying the image of file DSCF0004.JPG, the image is displayed with a slide-in effect on the screen to provide a presentation matching the dynamism of the subject to realize the slide show. When displaying the image of file DSCF0005.JPG, since the image is displayed calmly with the fade-in effect, the image can be appreciated as a subdued expression. Moreover, a similar effect can be achieved without changing effect types by merely switching the speed, the display start position, or the like of the slide-in effect among a plurality of stages in accordance with the displacement of the camera. In addition, the effects to be used are not limited to the slide-in effect and the fade-in effect, and a suitable effect may be used as appropriate.

While effects are switched depending on camera displacements in the present embodiment, effects may alternatively be switched depending on camera movement speeds calculated from the subject tracking times. Such a configuration enables slide shows to be enjoyed while recreating the aliveness and the sense of speed during photographing in a more realistic manner.

In addition, although a slide show display is performed on the image viewer 100 in the present embodiment, a similar slide show display may be performed in the playback mode of the digital camera 1. Furthermore, a slide show display can also be realized using a personal computer with a built-in image playback application program.

What is claimed is:

1. A photographic apparatus comprising:
an imaging device that periodically drives an imaging element during a still image photographing mode to photograph a plurality of images and which performs actual photographing of a still image when a photographing instruction is input;
a subject detecting device that detects an arbitrary subject from an image photographed prior to the actual photographing;
a measuring device that measures a period of time over which the subject had been continuously detected by the subject detecting device; and
an output device that outputs the measured period of time.

2. The photographic apparatus according to claim 1, wherein the imaging device performs actual photographing of one still image frame in association with a single photographing instruction when the measured period of time upon input of the photographing instruction is less than a first threshold, and consecutively at a predetermined time interval performs actual photographing of a plurality of still image frames in association with a single photographing instruction when the measured period of time upon input of the photographing instruction is equal to or greater than the first threshold.

3. The photographic apparatus according to claim 1, further comprising:
a device which detects an amount of a displacement of the photographic apparatus during the period of time over which a subject is continuously detected by the subject detecting device, wherein
conditions of actual photographing are set according to a movement speed of the photographic apparatus calculated based on the detected amount of the displacement or on the detected amount of the displacement and the measured period of time.

4. The photographic apparatus according to claim 3, wherein the greater the detected amount of the displacement or the greater the calculated movement speed, the higher the shutter speed or the photographic sensitivity during actual photographing is to be set.

5. The photographic apparatus according to claim 1, wherein the output device includes a recording control device that records a still image taken by actual photographing and the measured period of time with associating the still image with the measured period of time.

6. The photographic apparatus according to claim 5, wherein the recording control device records images of a predetermined time interval among images photographed prior to the actual photographing when the measured period of time reaches or exceeds a second threshold before the photographing instruction is input.

7. The photographic apparatus according to claim 5, wherein
the measuring device measures a period of time over which each of a plurality of subjects detected by the subject detecting device is continuously detected, and
the recording control device records a still image taken by actual photographing and the measured periods of time of photographed subjects in the still image with associating the still image with the measured period of time.

8. The photographic apparatus according to claim 5, wherein the recording control device records the still image taken by actual photographing and the detected amount of the displacement with associating the still image with the measured period of time.

9. An image display device which plays back and displays a still image recorded by the photographic apparatus according to claim 5 on a display device, the image display device comprising:
a device which acquires a still image recorded by the photographic apparatus and a measured period of time recorded in association with the still image;
a device which determines a display size of the still image based on the acquired measured period of time; and
a device which lists and displays a plurality of the acquired still images on the display device based on the determined display size.

10. An image display device which plays back and displays a still image recorded by the photographic apparatus according to claim 5 on a display device, the image display device comprising:
a device which acquires a still image recorded by the photographic apparatus and a measured period of time recorded in association with the still image;
a device which determines a display time of the still image based on the acquired measured period of time; and
a device which sequentially plays back and displays a plurality of the acquired still images on the display device based on the determined display time.

11. An image display device which plays back and displays a still image recorded by the photographic apparatus according to claim 8 on a display device, the image display device comprising:
a device which acquires a still image recorded by the photographic apparatus and a measured period of time recorded in association with the still image;
a device which determines, based on the acquired amount of the displacement, an image switching effect to be used when displaying the still image; and
a device which plays back and displays the still image on the display device based on the determined image switching effect.

12. A photographic system comprising:
an imaging device that periodically drives an imaging element during a still image photographing mode to photograph a plurality of images and which performs actual photographing of a still image when a photographing instruction is input;
a subject detecting device that detects an arbitrary subject from an image photographed prior to the actual photographing;
a measuring device that measures a period of time over which the subject had been continuously detected by the subject detecting device;
a recording control device which records a still image taken by actual photographing and the measured period of time with associating the still image with the measured period of time on a recording device;
a device which reads a still image and the measured period of time recorded in association with the still image from the recording device;
a device which determines a display size of the still image based on the read measured period of time; and
a device which lists and displays a plurality of the acquired still images on a display device based on the determined display size.

13. A photographic system comprising:
an imaging device that periodically drives an imaging element during a still image photographing mode to photograph a plurality of images and which performs actual photographing of a still image when a photographing instruction is input;
a subject detecting device that detects an arbitrary subject from an image photographed prior to the actual photographing;
a measuring device that measures a period of time over which the subject had been continuously detected by the subject detecting device;
a recording control device which records a still image taken by actual photographing and the measured period of time with associating the still image with the measured period of time on a recording device;
a device which reads a still image and the measured period of time recorded in association with the still image from the recording device;
a device which determines a display time of the still image based on the read measured period of time; and
a device which sequentially displays a plurality of the read still images on a display device based on the determined display time.

14. A photographic control method comprising the steps of:
an imaging step for periodically driving an imaging element during a still image photographing mode to photograph a plurality of images, and performing actual photographing of a still image when a photographing instruction is input;
a subject detecting step for detecting an arbitrary subject from an image photographed prior to the actual photographing;
a measuring step for measuring a period of time over which the subject had been continuously detected in the subject detecting step; and
an output step for outputting the measured period of time.

15. An image display method for playing back and displaying still images recorded by the photographic apparatus according to claim 3 on a display device, the image display method comprising the steps of:
a step for acquiring a still image recorded by the photographic apparatus and a measured period of time recorded in association with the still image;
a step for determining a display size of the still image based on the acquired measured period of time; and
a step for listing and displaying a plurality of the acquired still images on the display device based on the determined display size.

16. An image display method for playing back and displaying still images recorded by the photographic apparatus according to claim 3 on a display device, the image display method comprising the steps of:
a step for acquiring a still image recorded by the photographic apparatus and a measured period of time recorded in association with the still image;
a step for determining a display time of the still image based on the acquired measured period of time; and
a step for sequentially playing back and displaying a plurality of the acquired still images on the display device based on the determined display time.

17. A control method of a photographic system, comprising the steps of:
an imaging step for periodically driving an imaging element during a still image photographing mode to photograph a plurality of images, and performing actual photographing of a still image when a photographing instruction is input;
a subject detecting step for detecting an arbitrary subject from an image photographed prior to the actual photographing;
a measuring step for measuring a period of time over which the subject had been continuously detected in the subject detecting step;
a recording control step for recording a still image taken by actual photographing and the measured period of time with associating the still image and the measured period of time on a recording device;
a step for reading a still image and the measured period of time recorded in association with the still image from the recording device;
a step for determining a display size of the still image based on the read measured period of time; and
a step for listing and displaying a plurality of the acquired still images on a display device based on the determined display size.

18. A control method of a photographic system, comprising the steps of:
an imaging step for periodically driving an imaging element during a still image photographing mode to photograph a plurality of images, and performing actual photographing of a still image when a photographing instruction is input;
a subject detecting step for detecting an arbitrary subject from an image photographed prior to the actual photographing;
a measuring step for measuring a period of time over which the subject had been continuously detected in the subject detecting step;
a recording control step for recording a still image taken by actual photographing and the measured period of time with associating the still image and the measured period of time on a recording device;
a step for reading a still image and the measured period of time recorded in association with the still image from the recording device;
a step for determining a display time of the still image based on the read measured period of time; and
a step for sequentially displaying a plurality of the read still images on a display device based on the determined display time.

19. A programmable storage medium tangibly embodying a program of machine-readable instructions executable by a digital processing apparatus to perform an image control method, said method comprising the steps of:
an imaging step for periodically driving an imaging element during a still image photographing mode to photograph a plurality of images, and performing actual photographing of a still image when a photographing instruction is input;
a subject detecting step for detecting an arbitrary subject from an image photographed prior to the actual photographing;
a measuring step for measuring a period of time over which the subject had been continuously detected in the subject detecting step; and
an output step for outputting the measured period of time.

20. A programmable storage medium tangibly embodying a program of machine-readable instructions executable by a digital processing apparatus to execute an image display method for playing back and displaying still images recorded by the photographic apparatus according to claim 3 on a display device, the method comprising the steps of:
a step for acquiring a still image recorded by the photographic apparatus and a measured period of time recorded in association with the still image;
a step for determining a display size of the still image based on the acquired measured period of time; and
a step for listing and displaying a plurality of the acquired still images on the display device based on the determined display size.

21. A programmable storage medium tangibly embodying a program of machine-readable instructions executable by a digital processing apparatus to execute an image display method for playing back and displaying still images recorded by the photographic apparatus according to claim 3 on a display device, the method comprising the steps of:
a step for acquiring a still image recorded by the photographic apparatus and a measured period of time recorded in association with the still image;
a step for determining a display time of the still image based on the acquired measured period of time; and
a step for sequentially playing back and displaying a plurality of the acquired still images on the display device based on the determined display tune.

22. A programmable storage medium tangibly embodying a program of machine-readable instructions executable by a digital processing apparatus to perform a control method of a photographic system, said method comprising the steps of:
an imaging step for periodically driving an imaging element during a still image photographing mode to photograph a plurality of images, and performing actual photographing of a still image when a photographing instruction is input;
a subject detecting step for detecting an arbitrary subject from an image photographed prior to the actual photographing;
a measuring step for measuring a period of time over which the subject had been continuously detected in the subject detecting step;
a recording control step for recording a still image taken by actual photographing and the measured period of time with associating the still image with the measured period of time on a recording device;
a step for reading a still image and the measured period of time recorded in association with the still image from the recording device;
a step for determining a display size of the still image based on the read measured period of time; and
a step for listing and displaying a plurality of the acquired still images on a display device based on the determined display size.

23. A programmable storage medium tangibly embodying a program of machine-readable instructions executable by a digital processing apparatus to perform a control method of a photographic system, said method comprising the steps of:
an imaging step for periodically driving an imaging element during a still image photographing mode to photograph a plurality of images, and performing actual photographing of a still image when a photographing instruction is input;
a subject detecting step for detecting an arbitrary subject from an image photographed prior to the actual photographing;
a measuring step for measuring a period of time over which the subject had been continuously detected in the subject detecting step;
a recording control step for recording a still image taken by actual photographing and the measured period of time with associating the still image with the measured period of time on a recording device;
a step for reading a still image and the measured period of time recorded in association with the still image from the recording device;
a step for determining a display time of the still image based on the read measured period of time; and
a step for sequentially displaying a plurality of the read still images on a display device based on the determined display time.
